(19) United States
(12) Patent Application Publication
(10) Pub. No.: US 2003/0059748 A1
(43) Pub. Date: Mar. 27, 2003

(54) ReadSpeeder - a plastic for improving reading speed

(76) Inventor: John Catania, Aptos, CA (US)

Correspondence Address: John Catania, 173 Via Novella, Aptos, CA, 95003, US

(21) Appl. No.: 09/929,636

(22) Filed: Sep. 26, 2001

(51) Int. Cl. G09B 17/04

(52) U.S. Cl. 434/179

(57) ABSTRACT

The “ReadSpeeder” is a thin, flat piece of plastic, having an opaque upper and lower portion. Between the opaque portions is a clear strip or “window” through which lines of written words may be read. The device allows a person to manually regulate his or her reading speed and to focus his or her attention on groups of words rather than reading one word at a time.

### CROSS REFERENCE TO RELATED APPLICATION

Not applicable

### BACKGROUND

1. Field of Invention

This invention relates to the application of speed-reading techniques whereby the reader uses his or her hand or finger to manually determine reading speed.

2. Prior Art

As children, we are taught to read by pointing to a word and sounding it out. Speed-reading experts point out that the human eye takes in much more than a single word at a time and that the human brain is able to process much more than one word at a time. Thus, people learn to read at a pace that is much slower than their capability. To overcome this learned behavior, speed-reading professionals instruct students to use their finger or hand to manually “push” their line of sight and associated reading speed at a faster pace.

In addition to the hand or finger technique, speed-reading instructors may have students employ a device known as a “Reading Accelerator.” This device is a small projector that flashes lines of type onto a screen for a predetermined amount of time. For example, the machine can be set for 5 seconds, which results in a single line of type being flashed on the screen for a 5-second period. After 5 seconds, the next line of type is flashed on the screen.

### DISADVANTAGES OF THE PRIOR ART

The disadvantage of the finger or hand technique is that, even though the hand or finger is moving down the page rapidly, the reader's eye often remains fixed in one place and moves down the page much more slowly.

The disadvantage of the “Reading Accelerator” is that it is expensive, bulky, requires a power source, and can only be used with the text that has been loaded into the machine and not with the book you happen to be reading at any given time.

### SUMMARY

The “ReadSpeeder” is a thin piece of opaque plastic approximately 7″×2″ that has a clear center line ¼″ wide through which a single line of type can be read. By manually moving the “ReadSpeeder” over the pages of a typical book, magazine, or typed document, an average reader can apply basic speed-reading techniques and, thus, increase his or her reading speed.

### OBJECTS AND ADVANTAGES

Accordingly, in addition to the objects and advantages the “ReadSpeeder” described above, several objects and advantages of the “ReadSpeeder” are:

(a) helps young readers learn to read more than one word at a time

(b) helps remedial readers focus their attention

(c) helps older readers focus their attention

(d) allows normal readers to scan documents for specific facts or key words

(e) helps business people who deal with rows and columns of numerical data to scan across spreadsheets without inadvertently picking up a number from an adjacent line

(f) serves as a straight-edge for drawing lines

(g) serves as a bookmark

### DRAWING

FIG. 1 illustrates the “ReadSpeeder,” which is a single piece of plastic with no moving parts.

[image]

Operation

Operating the “ReadSpeeder” is very simple. First, place the “ReadSpeeder” at the top of a page of a typical book, magazine, or typed document, and then move it down to the bottom of the page at a rate that is faster than your normal reading speed.

For example, on average, it takes about 1 minute to read a page in a paperback book. In order to double this reading speed, that same page must be read in 30 seconds. To reach this speed and maintain comprehension, the reader must first condition himself or herself to read faster than the 30-second pace, and then “slow down” to 30 seconds. Therefore, to read at 30 seconds per page, first the reader must force himself or herself to read at a rate of 10 seconds per page. At this speed, the reader will comprehend very little, but reading 10 pages at 10 seconds will establish a pace in the reader's mind. Next, the reader will re-read those same 10 pages at a rate of 20 seconds per page. Comprehension will improve at this pace, but will still not be satisfactory. However, when the reader “slows down” to 30 seconds per page, comprehension will be quite good and the reader will have doubled his or her reading speed.

The simplest way for a reader to establish a reading speed (e.g. 10 seconds, 20 seconds, 30 seconds), is by counting as he or she slides the “ReadSpeeder” down the page. This will establish a rhythm or pace in the mind of the reading. Of course, it is also possible to use a timing device or have a friend count as the pages are read.

CONCLUSION, RAMIFICATION, AND SCOPE

Accordingly, the reader will see that the “ReadSpeeder” allows a person to manually regulate reading speed, while focusing attention on groups of words rather than on individual words. The “ReadSpeeder” helps children learn to read more efficiently. It helps older readers and individuals with reading problems focus their attention. It helps those who need to scan documents for specific words or data. It helps avoid inadvertently taking figures from adjacent lines when working with lists, and spreadsheets, and it serves as a straight-edge and bookmark.

[image]

1. I claim the “ReadSpeeder” is a handheld instrument comprising:
a. an elongated, flat piece of clear plastic that has been treated with shading except for a narrow strip running lengthwise through the center of the instrument, whereby text or numbers may be isolated from the rest of the document and read at a speed determined by the movement of the reader's hand.
